(19) United States
(12) Patent Application Publication
(10) Pub. No.: US 2008/0191002 A1
(43) Pub. Date: Aug. 14, 2008

(54) APPARATUS AND METHODS FOR LINING A CARTON WITH A LIQUID IMPERMEABLE LINER

(76) Inventor: Karl A. Kohler, Bartlett, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 12/030,723

(22) Filed: Feb. 13, 2008

Related U.S. Application Data
(60) Provisional application No. 60/889,586, filed on Feb. 13, 2007.

(51) Int. Cl. B65D 5/56; B31B 7/00

(52) U.S. Cl. 229/164.2; 493/93

(57) ABSTRACT

A liner assembly for lining a carton is provided. The liner assembly includes a frame having opposing end walls, and opposing side walls. The walls are connected together to define an open top portion and an open bottom portion. Each wall further includes a top edge, a bottom edge, an inner surface, and an outer surface. The liner assembly also includes a liquid impermeable liner that includes a body and a bottom. The liner body is coupled to at least one of the walls. The liner is extendible below the bottom portion of the frame.

### CROSS REFERENCE TO RELATED APPLICATIONS

This application claims the benefit of Provisional Application No. 60/889,586 filed on Feb. 13, 2007, which is hereby incorporated by reference in its entirety.

### BACKGROUND OF THE INVENTION

This invention relates generally to lining a carton with a liquid impermeable liner and, more particularly, to an apparatus and methods for lining a carton with a liquid impermeable liner for facilitating cooling of beverage containers stored within the carton.

Beverage containers, such as bottles and cans, are oftentimes packaged within a corrugated and/or paperboard carton for transport and sale to consumers. When a consumer receives and/or purchases the carton of beverage containers, the consumer may want to immediately cool the beverage containers (e.g., bottles) stored within the carton.

At least some known cartons are fabricated from rigid cardboard and include a liquid impervious coating applied to the inner surface of the carton or include a separate, liquid impervious liner placed within the carton. To cool the contents of these types of cartons, a consumer may pour a cooling liquid into the carton or place a relatively small amount of ice on top of the bottles within the carton. The coating or the separate liner prevents the cooling liquid or the water from the melting ice from contacting the cardboard. However, these cartons that have a liquid impervious coating or separate liner do not provide additional space for placing ice or other cooling means on the containers included within the carton. Accordingly, these cartons are limited in the amount of cooling they can provide.

In addition, the cost to construct and assemble such cardboard cartons having a liquid impervious coating and/or separate liner as described above is ever increasing and quite complex. Also, the coating on such cardboard cartons can inhibit the recyclability of the carton. Thus, an apparatus for lining a carton with a liquid impermeable liner that can easily be constructed and assembled is needed.

### BRIEF DESCRIPTION OF THE INVENTION

In one aspect, a liner assembly for lining a carton is provided. The liner assembly includes a frame having opposing end walls, and opposing side walls. The walls are connected together to define an open top portion and an open bottom portion. Each wall further includes a top edge, a bottom edge, an inner surface, and an outer surface. The liner assembly also includes a liquid impermeable liner that includes a body and a bottom. The liner body is coupled to at least one of the walls. The liner is extendible below the bottom portion of the frame.

In another aspect, a liquid impermeable carton system is provided. The system includes an outer carton having opposing end walls, opposing side walls, a bottom, and a cavity for housing a product. Each of the outer carton walls has a top edge. The system also includes a frame having opposing end walls, and opposing side walls. The frame walls are connected together to define an open top portion and an open bottom portion. Each of the frame walls further includes a top edge, a bottom edge, an inner surface, and an outer surface. The system further includes a liquid impermeable liner having a body and a bottom. The liner body is coupled to at least one of the frame walls and is extendible below the bottom portion of the frame. The outer carton is configured to receive the frame and the liner within the cavity with the product positioned within the liner. The frame is moveable relative to the outer carton from a first position wherein the frame is positioned within the cavity to a second position wherein at least a portion of the frame is positioned above the top edge of the outer carton.

In another aspect, a method for manufacturing a liquid impermeable carton system is provided. The method includes providing a frame having opposing end walls, and opposing side walls, wherein the walls are connected together to define an open top portion and an open bottom portion and wherein each wall further includes a top edge, a bottom edge, an inner surface, and an outer surface, attaching a liquid impermeable liner to at least one of the frame walls wherein the liquid impermeable liner includes a body and a bottom and wherein the liner is extendible below the bottom portion of the frame, and inserting the frame and the liner into an outer carton, wherein the outer carton includes opposing end walls, opposing side walls, a bottom, a closeable top, and a cavity for housing a product. Each outer carton wall includes a top edge. The liner is configured to receive a product therein, and the frame is moveable relative to the outer carton from a first position wherein the frame is positioned within the cavity to a second position wherein at least a portion of the frame is positioned above the top edge of the outer carton.

In a further aspect, an assembly for lining a carton with a liquid impermeable liner is provided. The carton holding a plurality of beverage containers and the assembly having a transport position and a cooling position. The assembly including a collapsible paperboard insert capable of being erected to a deployed articulated configuration, and a liquid impermeable bag attached to the paperboard insert. The paperboard insert including collapsible opposing end walls, opposing side walls attached to the opposing end walls, and a glue panel. Each wall has a height extending from a top edge to a bottom edge, and an inner surface and an outer surface. The glue panel outer surface is connected in a face-to-face relationship with the inner surface of one of the side walls and the glue panel is hingedly connected to the bottom edge of the other side wall when the insert is in an unarticulated configuration. The liquid impermeable bag having a top edge and a bottom edge. The bag connected to at least a portion of the inner surfaces of the end walls and the side walls wherein the top edge of the bag is proximate the top edge of the insert walls. The bag having a length greater than the height of the insert walls such that when the insert is in the unarticulated configuration the bag is folded and enclosed within the collapsed insert. The insert is deployed to the articulated configuration by moving the end walls inwardly, and breaking the hinged connection between the glue panel and the bottom edge of the side wall such that each end wall is generally parallel to the other end wall, each side wall is generally parallel to the other side wall, and the bag is expanded within the insert. In the transport position, the insert is positioned in the carton with the plurality of beverage containers positioned within the bag for transportation. The insert is moveable to the cooling position wherein the insert is upwardly moved relative to the beverage containers fully extending the length of the bag. In the cooling position, the assembly defining a volume above the beverage containers for receiving a cooling medium therein.

In a further aspect, a collapsible paperboard insert for lining a carton is provided. The insert includes a liquid impermeable bag attached thereto and is constructed from a paperboard blank. The insert includes collapsible opposing end walls constructed from at least two end panels, opposing side walls constructed from at least two side panels wherein the opposing side walls are attached to the opposing end walls, and a glue panel. Each panel has a height extending from a top edge to a bottom edge, and an inner surface and an outer surface. The liquid impermeable bag having a top edge and a bottom edge such that the bag is coupled to at least a portion of the inner surfaces of the end panels and the side panels where the top edge of the bag is proximate the top edge of the insert panels. The bag having a length greater than the height of the insert panels such that when the blank is in an unarticulated configuration, the bag is folded and enclosed within the collapsed insert. The insert is constructed by adhesively coupling the panels together. The insert is deployed to an articulated configuration by moving the end walls inwardly, and breaking a hinged connection between the glue panel and the bottom edge of the side panels.

### BRIEF DESCRIPTION OF THE DRAWINGS

FIG. 1 is a top plan view of a blank of sheet material for constructing a collapsible paperboard insert according to one embodiment.

FIG. 2 is a top plan view of a blank of sheet material for constructing a collapsible paperboard insert according to a first alternative embodiment of this invention.

FIG. 3 is a top plan view of an insert constructed from the blank shown in FIG. 1 including a bag attached thereto.

FIG. 4 is a top plan view of an assembly including the insert and bag shown in FIG. 3.

FIG. 5 is a top plan view of a partially constructed assembly shown in FIG. 4.

FIG. 6 is a top plan view of the partially constructed assembly shown in FIG. 5.

FIG. 7 is a top plan view of the assembly shown in FIG. 6 in an unarticulated configuration.

FIG. 8 is a perspective of the assembly shown in FIG. 7.

FIG. 9 is a perspective view of the assembly shown in FIG. 8 in an articulated configuration.

FIG. 10 is a perspective view of a carton.

FIG. 11 is a perspective view of the assembly shown in FIG. 8 partially inserted into the carton shown in FIG. 9.

FIG. 12 is a perspective view of the assembly shown in FIG. 8 inserted into the carton shown in FIG. 9.

FIG. 13 is a perspective view of the assembly shown in FIG. 8 in a transport position.

FIG. 14 is a perspective view of the assembly shown in FIG. 8 in a cooling position.

FIG. 15 is a top plan view of a blank of sheet material for constructing a collapsible paperboard insert according to a second alternative embodiment of this invention.

FIG. 16 is a top plan view of an assembly constructed from the blank shown in FIG. 15 including a bag and adhesive material attached thereto.

FIG. 17 is a top plan view of the assembly shown in FIG. 16 in an unarticulated configuration.

FIG. 18 is a perspective view of the assembly shown in FIG. 17 in an articulated configuration.

### DETAILED DESCRIPTION OF THE INVENTION

The present invention is described below in reference to its application in connection with and operation of an assembly for lining a carton including an insert and a liquid impermeable liner. However, it will be apparent to those skilled in the art and guided by the teachings herein provided that the invention is likewise applicable to any suitable storage and/or container including, without limitation, a carton, a tray or a box.

In one embodiment, the insert is fabricated from a paperboard material. The insert, however, may be fabricated using any suitable material, and therefore is not limited to a specific type of material. In alternative embodiments, the insert is fabricated using cardboard, corrugated board, plastic and/or any suitable material known to those skilled in the art and guided by the teachings herein provided. The insert may have any suitable size, shape and/or configuration, i.e. number of sides, whether such sizes, shapes and/or configurations are described and/or illustrated herein. For example, in one embodiment, the insert includes a shape that provides functionality, such as a shape that facilitates transporting the assembly and/or a shape that facilitates stacking and/or arrangement of a plurality of assemblies. Moreover, in one embodiment, the insert may be constructed by coupling various panels with glue, however, in an alternative embodiment, the various panels may be coupled using any suitable coupling mechanism such as, but not limited to, adhesive, resin, and/or a bonding agent.

In one embodiment, the insert may include a marking thereon including, without limitation, indicia that communicates the product, a manufacturer of the product and/or seller of the product. For example, the marking may include printed text that indicates a product's name and briefly describes the product, logos and/or trademarks that indicate a manufacturer and/or seller of the product, and/or designs and/or ornamentation that attract attention.

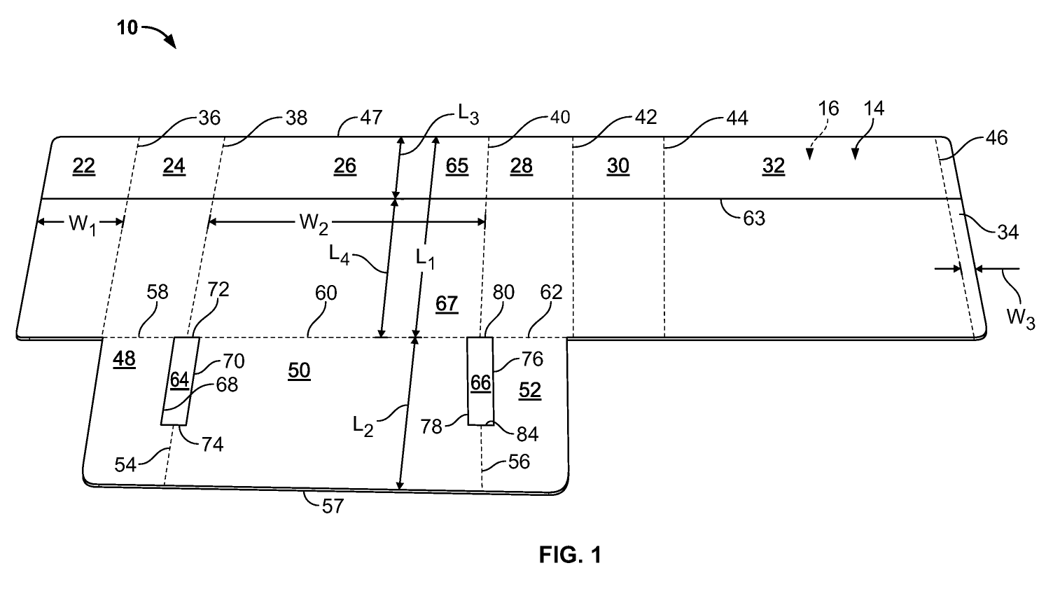

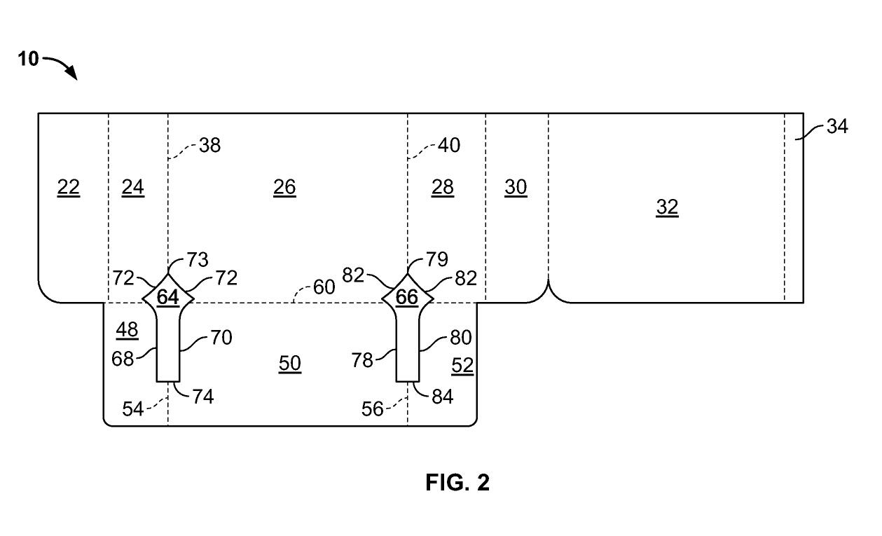

FIG. 1 is a top plan view of a blank of sheet material for constructing a collapsible paperboard insert for lining a carton according to one embodiment. FIG. 2 is a top plan view of a blank of sheet material for constructing a collapsible paperboard insert according to a first alternative embodiment of this invention.

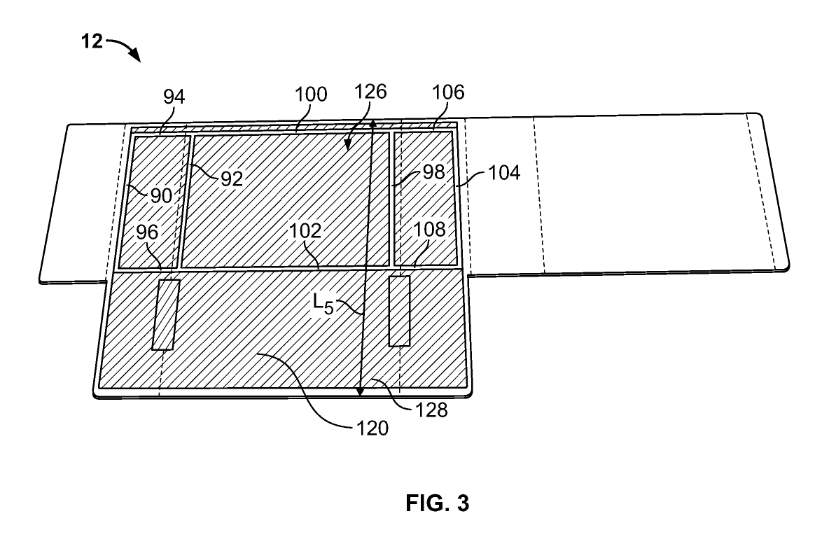

Referring now to the drawings, and more specifically to FIG. 1, a blank of sheet material 10 for constructing a collapsible paperboard insert designated in its entirety by the reference numeral 12 (shown in FIG. 3). Although the blank may include any suitable material without departing from the scope of the present invention, in one embodiment the blank includes flexible paperboard, cardboard, corrugated board, and/or plastic.

Blank 10 includes a first surface or internal surface 14 and an opposing second surface or external surface 16. Blank 10 further includes a succession of seven aligned rectangular panels 22, 24, 26, 28, 30, 32, and 34 that are connected together by a plurality of preformed, generally parallel, fold lines 36, 38, 40, 42, 44, and 46, respectively. Specifically, the seven aligned rectangular panels include a first end panel 22, a second end panel 24, a first side panel 26, a third end panel 28, a fourth end panel 30, a second side panel 32, and a closure panel 34. In one embodiment, the seven rectangular panels share a single top edge 47. The first end panel 22 extends from the second end panel 24 along fold line 36, the second end panel 24 extends from the first side panel 26 along fold line 38, the third end panel 28 extends from the first side panel 26 along fold line 40, the fourth end panel 30 extends from the third end panel 28 along fold line 42, the second side panel 32 extends from the fourth end panel 30 along fold line 44, and the closure panel 34 extends from the second side panel 32 along fold line 46. In one embodiment, fold lines 36, 38, 40, 42, 44, and 46 are perforated lines of separation. It is apparent to those skilled in the art and guided by the teachings herein provided that fold lines 36, 38, 40, 42, 44, and 46, as well as other fold lines described herein, may include any suitable line or lines of weakening. In an alternative embodiment, panels 22, 24, 26, 28, 30, 32, and 34 are any suitable shape.

In one embodiment, panels 22, 24, 26, 28, 30, 32 and 34 include four corners wherein each of the corners substantially forms a right angle (i.e. a 90 degree angle). In an alternative embodiment, shown in FIG. 2, at least one panel 22, 24, 26, 28, 30, 32, 34 includes at least one corner that is substantially arcuate.

Moreover, in one embodiment, panels 26 and 30 each include an opening (not shown) that facilitates use of insert 12, as will be described in further detail below.

In addition to the seven aligned panels, blank 10 includes a glue flap panel 50, and two glue flap panels 48 and 52 extending therefrom. Panels 48, 50, and 52 are connected together by preformed perforated lines of separation 54 and 56, respectively. Lines of separation 54 and 56 are generally parallel to each other and are coaxial with lines 38 and 40, respectively. In one embodiment, panels 48, 50, and 52 share a single bottom edge 57. The panel 48 extends from panel 50 along line of separation 54, and panel 50 extends from panel 52 along line of separation 56. Moreover, panel 48 extends from panel 24 along a line of separation 58, panel 50 extends from panel 26 along a line of separation 60, and panel 52 extends from panel 28 along a line of separation 62.

In one embodiment, panels 22, 24, 28, and 30 have a width W₁, panels 26 and 32 have a width W₂ that is greater than width W₁, and panel 34 has a width W₃ that is less than widths W₁ and W₂. For example, panel 24 has width W₁ that extends between fold line 36 and line 38, panel 26 has width W₂ that extends between fold lines 38 and 40, and panel 34 has width W₃ that extends from fold line 46.

Moreover, in one embodiment, panels 22, 24, 26, 28, 30, 32 and 34 have a length L₁, and panels 48, 50, and 52 have a length L₂ that is less than length L₁. For example, panel 24 has length L₁ that extends between top edge 47 and line of separation 58, and panel 50 has length L₂ that extends between line of separation 60 and bottom edge 57. In one embodiment, length L₁ is substantially equivalent to the summation of a length L₃ and a length L₄, and length L₄ is substantially equivalent to length L₂. For example, as shown on first side panel 26, length L₃ extends from top edge 47 towards a guide line 63, depicted in FIG. 1, and length L₄ extends from guide line 63 towards line of separation 60. In one embodiment, guide line 63 is depicted on blank 10 separating panels 22, 24, 26, 28, 30, 32, and 34 into a first portion 65 and a second portion 67.

Blank 10 further includes at least two cutout portions 64 and 66. In one embodiment, cutout portions 64 and 66 are substantially rectangular. Cutout portion 64 includes a first edge 68, an opposing second edge 70, and two substantially parallel edges 72 and 74 extending therebetween. Specifically, first edge 68 extends from line of separation 58 into a portion of glue flap panel 48, second edge 70 extends from line of separation 60 into a portion of glue flap panel 50, edge 72 is in communication with lines of separation 58 and 60 and is substantially perpendicular to line 38, and edge 74 is defined within a portion of glue flap panels 48 and 50 and is substantially perpendicular to line of separation 54. In an alternative embodiment, as shown in FIG. 2, cutout portion 64 has an arrow shape such that edges 68, 70, and 72 have an arcuate shape, and edge 72 has two portions that form an intersection 73 on line 38.

Similarly, cutout portion 66 includes a first edge 78, an opposing second edge 76, and two substantially parallel edges 80 and 84 extending therebetween. Specifically, first edge 78 extends from line of separation 60 into a portion of glue flap panel 50, second edge 76 extends from line of separation 62 into a portion of glue flap panel 52, edge 80 is in communication with lines of separation 60 and 62 and is substantially perpendicular to line 40, and edge 84 is defined within a portion of glue flap panels 50 and 52 and is substantially perpendicular to line of separation 56. In an alternative embodiment, as shown in FIG. 2, cutout portion 66 has an arrow shape such that edges 78, 80, and 82 have an arcuate shape, and edge 82 has two portions that form an intersection 79 on line 40. In an alternative embodiment, a relief area could be used instead of cutout portions 64 and 66.

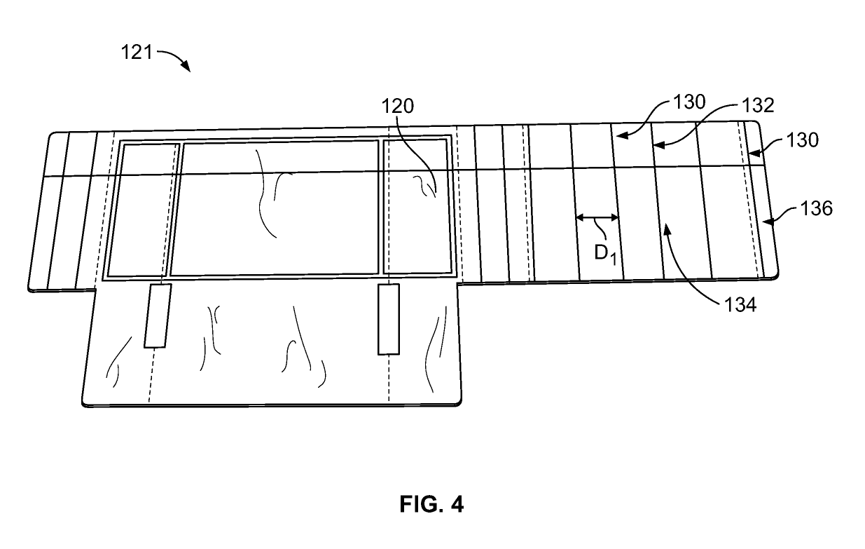

FIG. 3 is a top plan view of insert 12 constructed from blank 10 including a bag attached thereto, and FIG. 4 is a top plan view of an assembly 121, as will be described in more detail below.

An adhesive material is applied to a portion of internal surface 14 of blank 10. Specifically, adhesive material is applied to internal surfaces 14 of second end panel 24, first side panel 26, and third end panel 28. Moreover, the adhesive material facilitates coupling a bag to a portion of internal surface 14, as will be described in further detail below.

In one embodiment, the adhesive material is applied to second end panel 24 in a substantially rectangular shape such that the adhesive material includes a first adhesive portion 90, an opposing second adhesive portion 92, and adhesive portions 94 and 96 extending therebetween. Adhesive portion 90 is applied substantially parallel and adjacent line 36, adhesive portion 92 is applied substantially parallel and adjacent line 38, adhesive portion 94 is applied substantially parallel and adjacent top edge 47, and adhesive portion 96 is applied substantially parallel and adjacent line of separation 58. In an alternative embodiment, adhesive portion 92 is applied substantially parallel and adjacent line 38 and is applied to first side panel 26, rather than second end panel 24.

Similarly, in one embodiment, the adhesive material is applied to first side panel 26 in a substantially rectangular shape such that the adhesive material includes adhesive portion 92, an opposing adhesive portion 98, and adhesive portions 100 and 102 extending therebetween. Adhesive portion 98 is applied substantially parallel and adjacent line 40, adhesive portion 100 is applied substantially parallel and adjacent top edge 47 and is coaxial with adhesive portion 94, and adhesive portion 102 is applied substantially parallel and adjacent line of separation 60 and is coaxial with adhesive portion 96. In an alternative embodiment, adhesive portion 98 is applied substantially parallel and adjacent line 40 and is applied to third end panel 28, rather than first side panel 26.

Similarly, in one embodiment, the adhesive material is applied to third end panel 28 in a substantially rectangular shape such that the adhesive material includes adhesive portion 98, an opposing adhesive portion 104, and adhesive portions 106 and 108 extending therebetween. Adhesive portion 104 is applied substantially parallel and adjacent fold line 42, adhesive portion 106 is applied substantially parallel and adjacent top edge 47 and is coaxial with adhesive portions 94 and 100, and adhesive portion 108 is applied substantially parallel and adjacent line of separation 62 and is coaxial with adhesive portions 96 and 102.

In an alternative embodiment, the adhesive material applied to panels 24, 26, and 28 is applied in any suitable shape that facilitates adhesively coupling a bag to a portion of internal surface 14 of panels 24, 26, and 28.

After the adhesive material is applied to panels 24, 26, and 28, a bag 120 is coupled to blank 10 to construct insert 12. Specifically, bag 120 is positioned adjacent the adhesive material and adjacent a portion of internal surface 14 of blank 10. In one embodiment, bag 120 is a liquid impermeable bag configured to facilitate retaining liquid and/or ice without leaking.

Specifically, bag 120 includes a top edge 126 and an opposing bottom 128. In one embodiment, bag 120 has a substantially rectangular shape and is sized to substantially cover panels 24, 26, 28, 48, 50, and 52. Bag 120 is adhesively coupled to internal surface 14 of panels 24, 26, and 28 by adhesive portions 90, 92, 94, 96, 98, 100, 102, 104, 106, and 108. Moreover, top edge 126 of bag 120 is positioned adjacent to top edge 47 of panels 24, 26, and 28, and bottom 128 of bag 120 is positioned adjacent to bottom edge 57 of panels 48, 50, and 52. In an alternative embodiment, bag 120 has any suitable shape that facilitates retaining liquid.

Moreover, an adhesive material is applied to a portion of insert 12 to facilitate constructing assembly 121. Specifically, an adhesive material is applied to a portion of internal surface 14 of first end panel 22, fourth end panel 30, second side panel 32, and closure panel 34 outside of bag 120. In one embodiment, the adhesive material applied to panels 22, 30, 32, and 34 is applied in linear strips 130. Linear strips 130 are separated by a distance D₁. In one embodiment, each linear strip 130 includes a first portion 132 and a second portion 134 on panels 22, 30, 32 and 34. Portions 132 and 134 are substantially perpendicular to top edge 47. For example, as shown in FIG. 4, first portion 132 of linear strip 130 is applied to first portion 65 of panels 22, 30, 32 and 34 having a length substantially equal to length L₃, and second portion 134 of linear strip 130 is applied to second portion 67 of panels 22, 30, 32 and 34 having a length substantially equal to length L₄. First portion 132 extends approximately from top edge 47 towards guide line 63, and second portion 134 extends approximately from guide line 63 towards line of separation 60. In an alternative embodiment, linear strips 130 include a single portion 136 as shown, for example, on panel 34 having a length substantially equal to length L₁. In an alternative embodiment, the adhesive material is applied to a portion of internal surface 14 of first end panel 22, fourth end panel 30, second side panel 32, and closure panel 34 in any suitable shape.

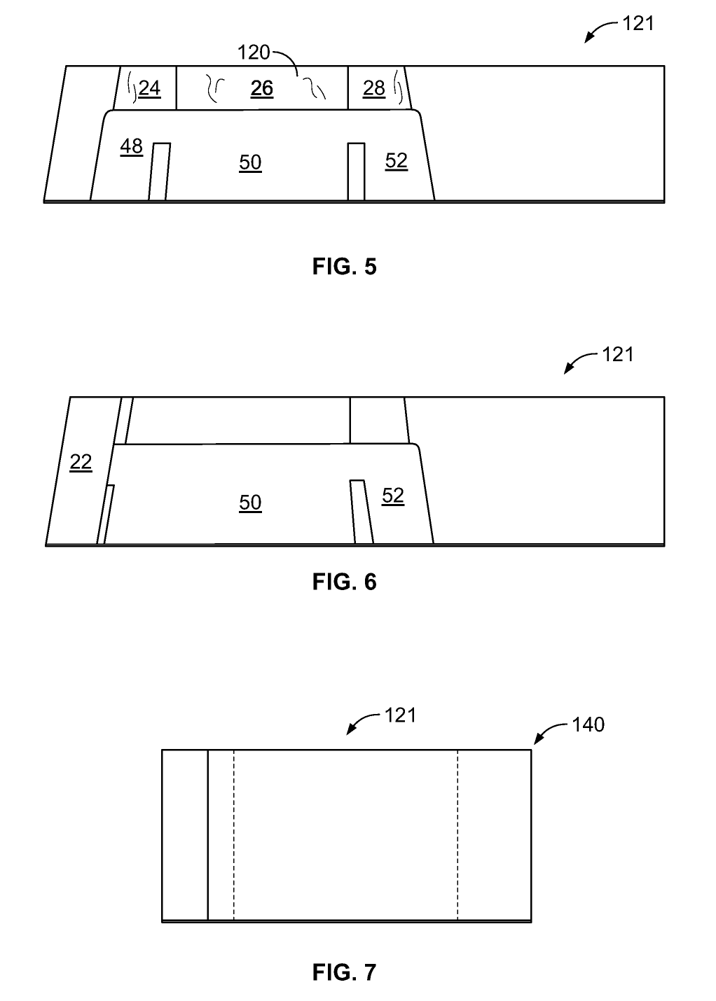

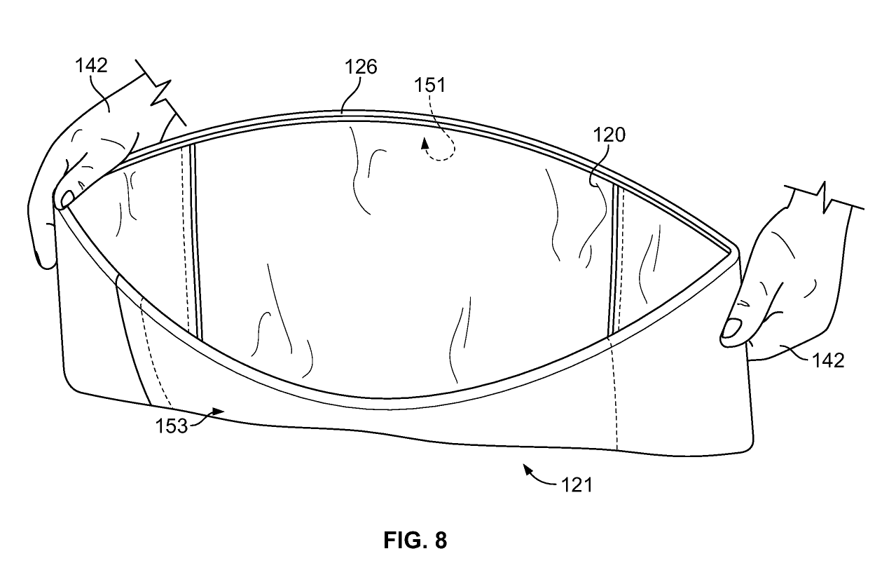

FIG. 5 is a top plan view of a partially constructed assembly 121, FIG. 6 is a top plan view of partially constructed assembly 121, and FIG. 7 is a top plan view of assembly 121 in an unarticulated configuration 140.

To construct assembly 121 into unarticulated or collapsible configuration 140 (shown in FIG. 7), panels 48, 50, and 52 of assembly 121 are rotated substantially simultaneously along lines of separation 58, 60, and 62 towards internal surface 14 of panels 24, 26, and 28, respectively. Bag 120 is folded simultaneously as panels 48, 50, and 52 are rotated towards panels 24, 26, and 28. When panels 48, 50, and 52 have been rotated, bag 120 is positioned between internal surface 14 of panels 24, 26, 28 and internal surface 14 of panels 48, 50, and 52.

As shown in FIG. 6, first end panel 22 is then rotated along fold line 36 towards external surface 16 of panel 48. The adhesive material applied to panel 22 adhesively couples first end panel 22 to a portion of panel 48 and a portion of bag 120.

Panels 30, 32 and 34 are then rotated along fold line 42 towards external surface 16 of panel 48. The adhesive material applied to panels 30 and 32 adhesively couples panels 30 and 32 to bag 120 and panels 52 and 50, respectively. Furthermore, the adhesive material applied to panel 34 adhesively couples panel 34 to first end panel 22.

As shown in FIG. 7, assembly 121 is in an unarticulated configuration 140 facilitating shipping, transporting, and/or storing of assembly 121. Moreover, when assembly 121 is in unarticulated configuration 140, bag 120 is folded and enclosed within insert 12.

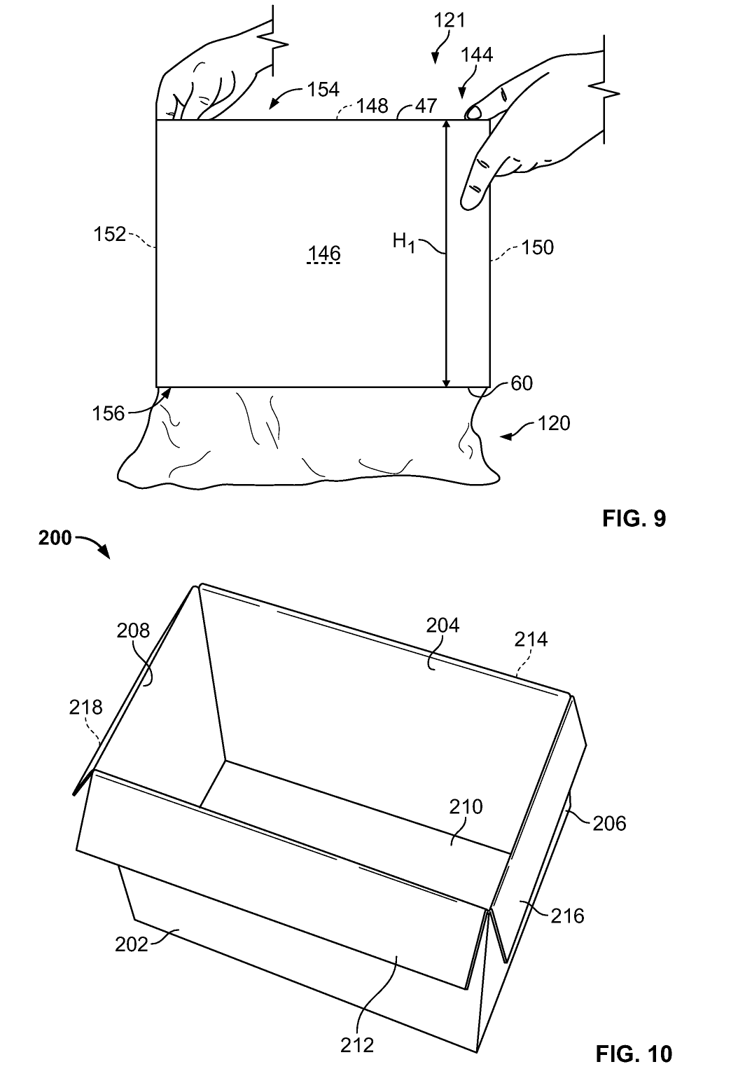

FIG. 8 is a perspective view of assembly 121, and FIG. 9 is a perspective view of assembly 121 in an articulated configuration 144.

Assembly 121 is capable of being erected from unarticulated configuration 140 to deployed articulated configuration 144. In one embodiment, a user 142 and/or a machine (not shown) separates or breaks the connection of panels 24, 26, and 28 from panels 48, 50, and 52, respectively, along lines of separation 58, 60, and 62. In one embodiment, user 142 may separate lines of separation 58, 60, and 62 using any suitable method.

Once lines of separation 58, 60, and 62 are separated, pressure is exerted inwardly along panels 22 and 24 and along panels 28 and 30 to articulate assembly 121. Specifically, first side panel 26 forms a first side wall 146. Second side panel 32 and panel 50 form a second side wall 148. First end panel 22, second end panel 24, closure panel 34, and panel 48 form a first end wall 150 extending between first and second side walls 146 and 148. Third end panel 28, fourth end panel 30, and panel 52 form a second end wall 152 extending between first and second side walls 146 and 148. As walls 146, 148, 150, and 152 are formed, bag 120 is expanded.

In articulated configuration 144, end walls 150 and 152 are generally parallel and side walls 146 and 148 are generally parallel. Each wall 146, 148, 150, and 152 has a height H₁ extending from top edge 47 to line of separation 60. Moreover, each wall 146, 148, 150, and 152 has an inner surface 151 and an outer surface 153.

In articulated configuration 144, exterior surface 16 of panel 48 is connected in a face-to-face relationship with inner surface 151 of end wall 150, and exterior surface 16 of panel 52 is connected in a face-to-face relationship with inner surface 151 of end wall 152, and exterior surface 16 of panel 50 is connected in a face-to-face relationship with inner surface 151 of side wall 148.

Assembly 121 in articulated configuration 144 also includes a top opening 154 and a bottom opening 156. Bottom opening 156 results from the separation of panels 24, 26, and 28 and panels 48, 50, and 52 along lines of separation 58, 60, and 62.

In one embodiment, in articulated configuration 144, bag 120 is connected to at least a portion of inner surfaces 151 of walls 146, 148, 150, and 152 wherein top edge 126 of bag 120 is proximate top edge 47. Moreover, in one embodiment, bag 120 has a length L₈ (shown in FIG. 3) that is greater than the height H₁ of assembly 121 in articulated configuration 144 such that bag 120 extends through bottom opening 156 of assembly 121 in articulated configuration 144.

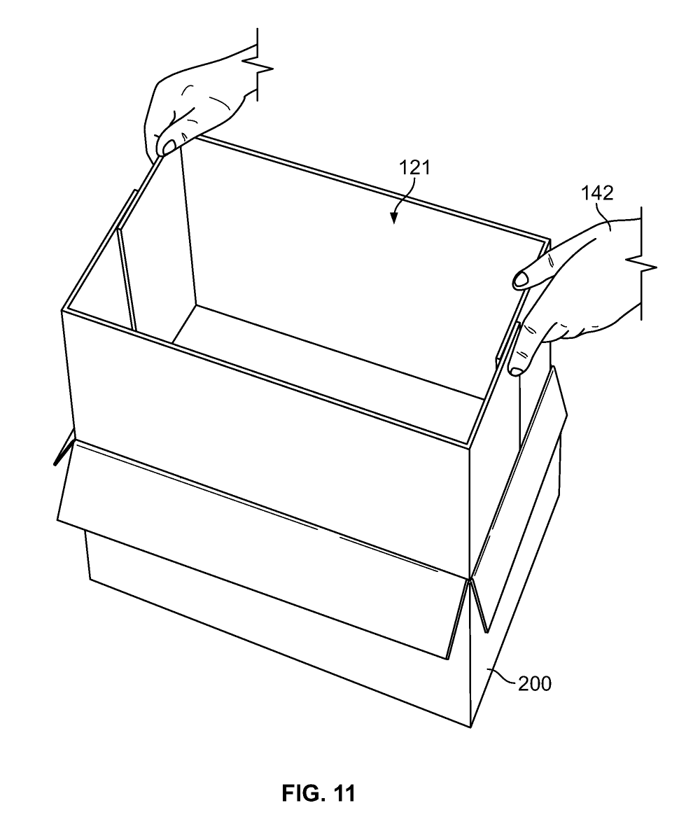

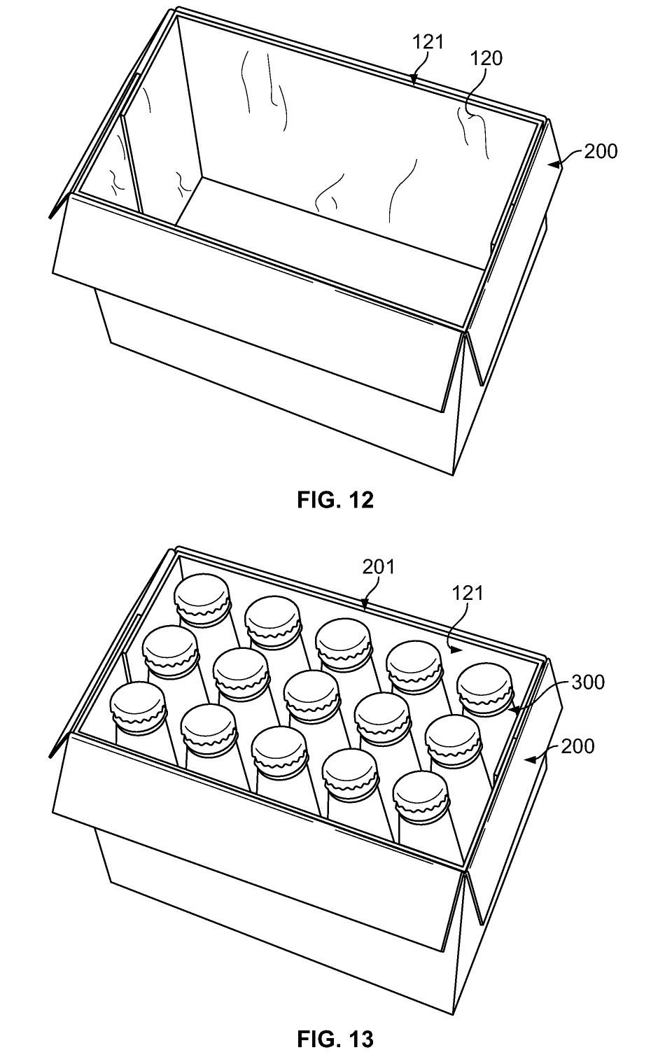

FIG. 10 is a perspective view of a carton 200, FIG. 11 is a perspective view of assembly 121 in articulated configuration 144 and partially inserted into carton 200, and FIG. 12 is a perspective view of assembly 121 in articulated configuration 144 and inserted into carton 200.

Once in articulated configuration 144, assembly 121 is inserted at least partially into carton 200. Carton 200 is any suitable carton configured to receive assembly 121. Specifically, in one embodiment, carton 200 is rectangular and includes a first side wall 202, an opposing second side wall 204, and a first and a second end wall 206 and 208 extending therebetween. Carton 200 further includes a bottom wall 210, and a top wall (not shown) formed by a set of end panels 212, 214, 216, and 218 extending from walls 202, 204, 206, and 208, respectively. Panels 212, 214, 216, and 218 may have any suitable shape, size, and arrangement that facilitates forming the top wall. In one embodiment, assembly 121 in articulated configuration 144 is inserted into carton 200 such that first side wall 146 is positioned adjacent first side wall 202, second side wall 148 is positioned adjacent second side wall 204, first end wall 150 is positioned adjacent first end wall 206, and second end wall 152 is positioned adjacent second end wall 208. Moreover, assembly 121 is inserted into carton 200 such that bottom 128 of bag 120 is adjacent bottom wall 210 of carton 200. In an alternative embodiment, assembly 121 in articulated configuration 144 is inserted into carton 200 in any suitable manner and/or arrangement such that carton 200 receives assembly 121.

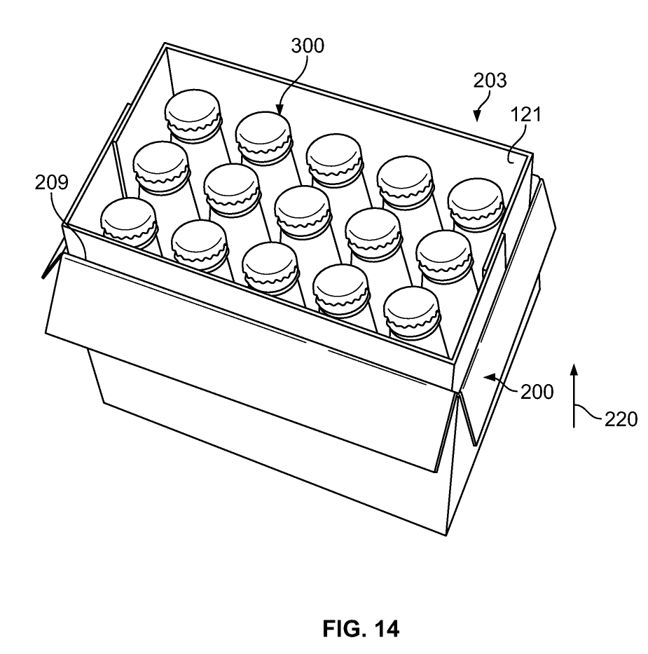

FIG. 13 is a perspective view of assembly 121 in a transport position, and FIG. 14 is a perspective view of the assembly 121 in a cooling position.

Once assembly 121 is inserted into carton 200, a plurality of beverage containers 300 such as, but not limited to, aluminum bottles, glass bottles, and/or aluminum cans are inserted into bag 120 for transportation and/or distribution. Once containers 300 are placed within bag 120, assembly 121 is in a transport position 201.

To use assembly 121, assembly 121 is moveable from the transport position 201 to a cooling position 203. To move assembly 121 to cooling position 203, assembly 121 is moved in an upward direction 220, shown on FIG. 14, relative to containers 300. Assembly 121 is moved in upward direction 220 until the length L₈ (shown in FIG. 3) of bag 120 is fully extended.

In one embodiment, user 142 and/or a mechanism (not shown) utilizes the openings (not shown) formed in first and second side walls 146 and 148 of assembly 121 to pull assembly 121 in upward direction 220. Moreover, user 142 may apply pressure to containers 300 while simultaneously pulling assembly 121 in upward direction 220.

In cooling position 203, a portion of assembly 121 extends above a top edge 209 of side and end walls 202, 204, 206, and 208 of carton 200 defining a volume above containers 300. The volume is configured to receive a cooling medium therein. The cooling medium may be, but is not limited to, ice and/or cooling liquid. The cooling medium facilitates cooling containers 300, and bag 120 is configured to prevent the cooling substance from leaking into carton 200.

After using assembly 121 in articulated position 144, assembly 121 may be collapsed and returned to unarticulated configuration 140.

Although the assembly as described herein is used for cooling beverage containers, it can also be used for shipping and storing any product that may be combined with a cooling or liquid medium. For example, the lined carton could also be used for shipping a plant within soil. The liner would protect the carton from the moisture of the soil and would allow the plant to be watered while in the carton.

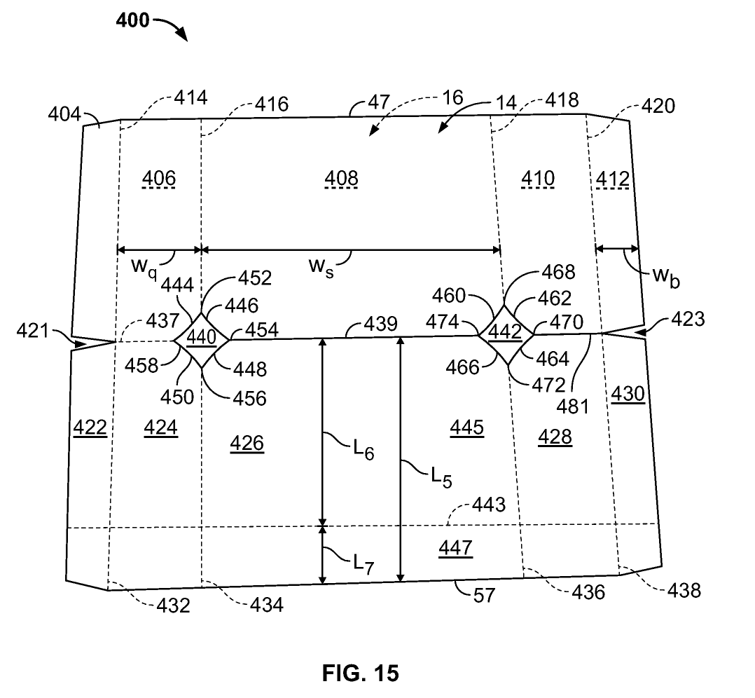

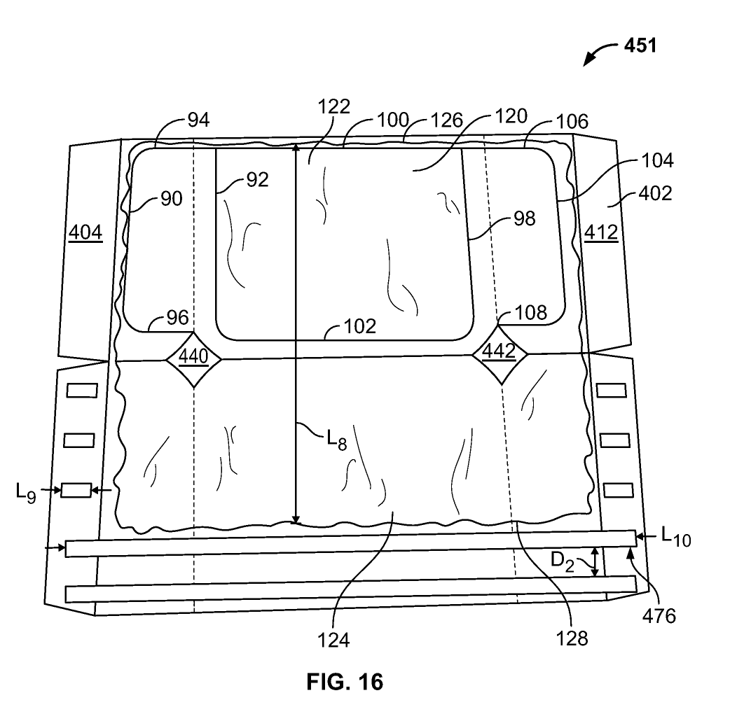

FIG. 15 is a top plan view of a blank of sheet material 400 for constructing a collapsible paperboard insert 402 (shown in FIG. 16) according to a second alternative embodiment of this invention. Blank 400 is similar to blank 10 from FIG. 1, and like components are identified with like reference numerals. Although blank 400 may include any suitable material without departing from the scope of the present invention, in one embodiment blank 400 includes flexible paperboard, cardboard, corrugated board, and/or plastic.

Blank 400 includes internal surface 14 and external surface Blank 400 further includes a succession of five aligned rectangular panels 404, 406, 408, 410, and 412 that are connected together by a plurality of preformed, generally parallel, fold lines 414, 416, 418, and 420, respectively. Specifically, the aligned rectangular panels include a first panel 404, a second panel 406, a third panel 408, a fourth panel 410, and a fifth panel 412. In one embodiment, the five rectangular panels share single top edge 47. First panel 404 extends from second panel 406 along fold line 414, third panel 408 extends from second panel 406 along fold line 416, fourth panel 410 extends from third panel 408 along fold line 418, and fifth panel 412 extends from fourth panel 410 along fold line 420. In an alternative embodiment, panels 404, 406, 408, 410, and 412 are any suitable shape.

In one embodiment, panels 404, 406, 408, 410, and 412 include four corners wherein each of the corners substantially forms a right angle (i.e. a 90 degree angle). In an alternative embodiment, at least one panel 404, 406, 408, 410, and 412 includes at least one corner that forms an angle that is less than 90 degrees such that panels 404 and 422 form a first notch 421, and panels 412 and 430 form a second notch 423.

Blank 400 further includes a succession of five aligned glue flap panels 422, 424, 426, 428, and 430 that are connected together by a plurality of preformed fold lines 432, 434, 436, and 438, respectively. Fold lines 432, 434, 436, and 438 are generally parallel to each other and coaxial with fold lines 414, 416, 418, and 420, respectively. Specifically, the glue flap panels include a first glue flap panel 422, a second glue flap panel 424, a third glue flap panel 426, a fourth glue flap panel 428, and a fifth glue flap panel 430. In one embodiment, the glue flap panels 422, 424, 426, 428, and 430 share single bottom edge 57. First glue flap panel 422 extends from second glue flap panel 424 along fold line 432, third glue flap panel 426 extends from second glue flap panel 424 along fold line 434, fourth glue flap panel 428 extends from third glue flap panel 426 along fold line 436, and fifth glue flap panel 430 extends from fourth glue flap panel 428 along fold line 438. Moreover, second glue flap panel 424 extends from second panel 406 along a line of separation 437, third glue flap panel 426 extends from third panel 408 along a line of separation 439, and fourth glue flap panel 428 extends from fourth panel 410 along a line of separation 441.

In one embodiment, panels 406, 410, 424, and 428 have a width W₄, panels 408 and 426 have a width W₅ that is greater than width W₄, and panels 404, 412, 422, and 430 have a width W₆ that is less than widths W₄ and W₅. For example, panel 406 has width W₄ that extends between fold line 414 and fold line 416, panel 408 has width W₅ that extends between fold line 416 and fold line 418, and panel 412 has width W₆ that extends from fold line 420. Moreover, in one embodiment, panels 404, 406, 408, 410, 412, 422, 424, 426, 428, and 430 have a length L₅.

In one embodiment, length L₅ is the summation of the addition of a length L₆ and a length L₇ that is less than length L₆. For example, as shown on panel 426, length L₆ extends from line of separation 439 towards a guide line 443, depicted in FIG. 15, and length L₇ extends from guide line 443 towards edge 57. In one embodiment, guide line 443 is depicted on blank 400 such that guide line 443 separates panels 422, 424, 426, 428, and 430 into a first portion 445 and a second portion 447.

Blank 400 further includes at least two cutout portions 440 and 442. In one embodiment, cutout portions 440 and 442 are substantially diamond shaped. Specifically, cutout portion 440 includes a first edge 444, a second edge 446, a third edge 448, and a fourth edge 450. In one embodiment, edges 444 and 446 form an intersection 452 positioned along fold line 416, edges 446 and edges 448 form an intersection 454 positioned along line of separation 439, edges 448 and 450 form an intersection 456 positioned along fold line 434, and edges 444 and 450 form an intersection 458 positioned along line of separation 437. Similarly, cutout portion 442 includes a first edge 460, a second edge 462, a third edge 464, and a fourth edge 466. In one embodiment, edges 460 and 462 form an intersection 468 positioned along fold line 418, edges 462 and edges 464 form an intersection 470 positioned along fold line of separation 441, edges 464 and 466 form an intersection 472 positioned along fold line 436, and edges 466 and 460 form an intersection 474 positioned along line of separation 439. In an alternative embodiment, edges 444, 446, 448, 450, 460, 462, 464, and 466 of cutout portions 440 and 442 have an arcuate shape or any suitable shape. In an alternative embodiment, a relief area is included in blank 400 rather than cutout portions 440 and 442.

FIG. 16 is a top plan view of an assembly 451 constructed from blank 400 including bag 120 and adhesive material attached thereto. Referring to FIG. 16, an adhesive material is applied to a portion of internal surface 14 of blank 400 to facilitate assembly of insert 402. Specifically, the adhesive material is applied to a portion of internal surface 14 of second panel 406, third panel 408, and fourth panel 410 to facilitate assembly of insert 402. The adhesive material facilitates coupling bag 120 to a portion of internal surface 14, as will be described in further detail below. Specifically, in one embodiment, the adhesive material is applied to second panel 406 in a substantially rectangular shape such that the adhesive material includes first adhesive portion 90, opposing second adhesive portion 92, and adhesive portions 94 and 96 extending therebetween. Adhesive portion 90 is applied substantially parallel and adjacent fold line 414, adhesive portion 92 is applied substantially parallel and adjacent fold line 416, adhesive portion 94 is applied substantially parallel and adjacent top edge 47, and adhesive portion 96 is applied substantially parallel and adjacent line of separation 437. In an alternative embodiment, as shown in FIG. 16, adhesive portion 92 is applied substantially parallel and adjacent fold line 416 and is applied to third panel 408, rather than second panel 406.

Similarly, in one embodiment, the adhesive material is applied to panel 408 in a substantially rectangular shape such that the adhesive material includes adhesive portion 92, an opposing adhesive portion 98, and adhesive portions 100 and 102 extending therebetween. Adhesive portion 98 is applied substantially parallel and adjacent fold line 418, adhesive portion 100 is applied substantially parallel and adjacent top edge 47 and is coaxial with adhesive portion 94, and adhesive portion 102 is applied substantially parallel and adjacent line of separation 439 and is coaxial with adhesive portion 96. In an alternative embodiment, adhesive portion 98 is applied substantially parallel and adjacent fold line 418 and is applied to fourth panel 410, rather than third panel 408.

Similarly, in one embodiment, the adhesive material is applied to panel 410 in a substantially rectangular shape such that the adhesive material includes adhesive portion 98, an opposing adhesive portion 104, and adhesive portions 106 and 108 extending therebetween. Adhesive portion 104 is applied substantially parallel and adjacent fold line 420, adhesive portion 106 is applied substantially parallel and adjacent top edge 47 and is coaxial with adhesive portions 94 and 100, and adhesive portion 108 is applied substantially parallel and adjacent line of separation 441 and is coaxial with adhesive portions 96 and 102.

Specifically, to facilitate constructing assembly 451, bag 120 is positioned adjacent the adhesive material and adjacent a portion of internal surface 14 of insert 402. In one embodiment, bag 120 is a liquid impermeable bag configured to facilitate retaining liquid and/or ice without leaking.

In an alternative embodiment, the adhesive material applied to panels 406, 408, and 410 is applied in any suitable shape that facilitates adhesively coupling bag 120 to a portion of internal surface 14 of panels 406, 408, and 410.

After the adhesive material is applied to panels 406, 408, and 410 of insert 402, bag 120 is positioned adjacent a portion of insert 402 to facilitate constructing assembly 451. In one embodiment, bag 120 has a substantially rectangular shape such that first and second portions 122 and 124 are each sized to substantially cover panels 406, 408, and 410 and a portion of panels 424, 426, and 428, respectively. In one embodiment, bag 120 is positioned substantially planar with insert 402. Bag 120, specifically first portion 122, is adhesively coupled to internal surface 14 of panels 406, 408, and 410 along adhesive portions 90, 92, 94, 96, 98, 100, 102, 104, 106, and 108. Top edge 126 of bag 120 is positioned adjacent to top edge 47 of panels 406, 408, and 410, and bottom 128 of bag 120 is positioned adjacent guide line 443 and extends across panels 424, 426, and 428. In an alternative embodiment, bag 120 has any suitable size and/or shape that facilitates retaining liquid.

After bag 120 has been coupled to a portion of insert 402, an adhesive material is applied to a portion of internal surface 14 of panels 422, 424, 426, 428, and 430 to facilitate constructing assembly 451. Specifically, in one embodiment, the adhesive material applied to panels 422, 424, 426, 428, and 430 is applied in linear strips 476. Linear strips 476 are separated by a distance D₂. In one embodiment, linear strips 476 have two different lengths, a first length L₉ and a second length L₁₀ that is longer than first length L₉. Specifically, panels 422 and 430 each includes a plurality of linear strips 476 having first length L₉ that substantially extend the width W₆ of panels 422 and 430 and are substantially parallel to lines of separation 437 and 441, respectively. Moreover, panels 422, 424, 426, 428, and 430 include a plurality of linear strips 476 having second length L₁₀ that substantially extend across each panel 422, 424, 426, 428, and 430 and are substantially parallel to lines of separation 437, 439, and 441. Moreover, in one embodiment, linear strips 476 having second length L₁₀ are positioned between guide line 443 and edge 57. In an alternative embodiment, the adhesive material applied to a portion of internal surface 14 panels 422, 424, 426, 428, and 430 may be any suitable shape and/or size that facilitates constructing assembly 451.

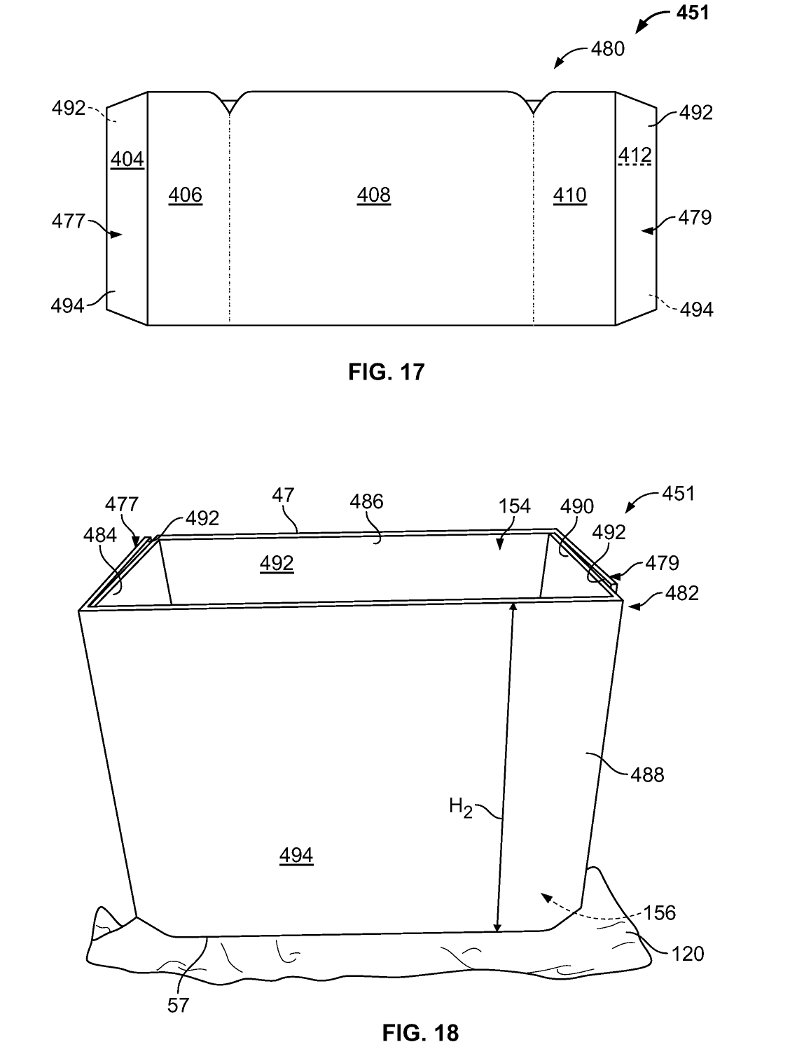

FIG. 17 is a top plan view of assembly 451 in an unarticulated configuration 480. To construct assembly 451 into unarticulated or collapsible configuration 480, panels 422, 424, 426, 428, and 430 are rotated substantially simultaneously along lines of separation 437, 439, and 441 towards internal surface 14 of panels 404, 406, 408, 410, and 412, respectively. Bag 120 is folded as panels 422, 424, 426, 428, and 430 are rotated towards panels 404, 406, 408, 410, and 412. When panels 404, 406, 408, 410, and 412 have been rotated, bag 120 is positioned between internal surface 14 of panels 406, 408, and 410 and internal surface 14 of panels 424, 426, and 428.

The adhesive material applied to panels 406, 408, and 410 adhesively couples bag 120 to panels 406, 408, and 410. Moreover, the adhesive material applied to panels 424, 426, and 428 adhesively couples panels 424, 426, and 428 to bag 120. The adhesive material applied to panels 422 and 430 adhesively couples panels 422 and 430 to panels 404 and 412, respectively. Specifically, linear strips 476 having first length L₉ on panels 422 and 430 adhesively couple panels 422 and 430 to panels 404 and 412, respectively. Moreover, linear strips 476 having second length L₁₀ on panels 422, 424, 426, 428, and 430 adhesively couple panels 422, 424, 426, 428, and 430 to panels 404 and 412 and to first portion 122 of bag 120.

After panels 404 and 422 are adhesively coupled, a first end wall extension 477 is formed. Similarly, after panels 412 and 430 are adhesively coupled, a second end wall extension 479 is formed.

As shown in FIG. 17, assembly 451 is in unarticulated configuration 480 facilitating shipping, transporting, and/or storing of assembly 451. Moreover, when assembly 451 is in unarticulated configuration 480, bag 120 is folded and enclosed within insert 402.

FIG. 18 is a perspective view of the assembly 451 in an articulated configuration 482. Assembly 451 is capable of being erected to deployed articulated configuration 482 from unarticulated configuration 480. To erect assembly 451, user 142 and/or a machine (not shown) separates panels 406, 408, and 410 from panels 424, 426, and 428, respectively, along lines of separation 437, 439, and 441. Once lines of separation 437, 439, and 441 are separated, pressure is exerted inwardly along end wall extensions 477 and 479 to form various walls.

Assembly 451 in articulated configuration 482 is substantially rectangular. Specifically, panels 406 and 424 form a first end wall 484, panel 408 forms a first side wall 486, panel 426 forms a second side wall 488, and panels 410 and 428 form a second end wall 490. Assembly 451 in articulated configuration 482 also includes top opening 154 and bottom opening 156. As walls 484, 486, 488, and 490 are formed, bag 120 is expanded.

In articulated configuration 482, end walls 484 and 490 are generally parallel and side walls 486 and 488 are generally parallel. Each wall 484, 486, 488, and 490 has a height H₂ extending from top edge 47 to line of separation 439. Moreover, each wall 484, 486, 488, 490 and each extension 477 and 479 has an inner surface 492 and outer surface 494.

In articulated configuration 482, inner surface 492 of extension 477 is connected in a face-to-face relationship with outer surface 494 of end wall 484, and inner surface 492 of extension 479 is connected in a face-to-face relationship with outer surface 494 of end wall 490.

Assembly 451 in articulated configuration 482 also includes top opening 154 and bottom opening 156. Bottom opening 156 results from the separation of panels 406, 408, and 410, and panels 424, 426, and 428 along lines of separation 437, 439, and 441.

In one embodiment, in articulated configuration 482, bag 120 is connected to at least a portion of inner surfaces 492 of walls 484, 486, 488, 490 wherein top edge 126 of bag 120 is proximate top edge 47. Moreover, in one embodiment, bag 120 has a length L₈ that is greater than the height H₂ of assembly 451 in articulated configuration 482 such that bag 120 extends through bottom opening 156 of assembly 451.

Once assembly 451 is in articulated configuration 482, assembly 451 is inserted at least partially into carton 200. Assembly 451 is inserted into carton 200, operates, and is used in a manner substantially similar to the operation and use of assembly 121 as described above and shown in FIGS. 1 through 14.

While the invention has been described in terms of various specific embodiments, those skilled in the art will recognize that the invention can be practiced with modification within the spirit and scope of the claims.

1. A liner assembly for lining a carton, said liner assembly comprising:
a frame comprising opposing end walls, and opposing side walls, said walls being connected together defining an open top portion and an open bottom portion, each wall further comprising a top edge, a bottom edge, an inner surface, and an outer surface; and
a liquid impermeable liner comprising a body and a bottom, said liner body coupled to at least one of said walls, said liner extendible below said bottom portion of said frame.

2. A liner assembly in accordance with claim 1, wherein said liner body is coupled to said inner surface of each of said walls, said liner body extending along said inner surfaces of said walls and extendible below said bottom portion of said frame such that when said liner is fully extended said liner bottom is positioned below said bottom portion of said frame.

3. A liner assembly in accordance with claim 1, wherein said walls are joined along a plurality of substantially parallel fold lines such that said frame is collapsible, said plurality of fold lines extending from said top edge to said bottom edge of said walls.

4. A liner assembly in accordance with claim 1, wherein said liner body is adhesively coupled to each of said walls.

5. A liner assembly in accordance with claim 1, wherein each of said opposing end walls comprises two end panels connected together along a central fold line, wherein said frame is collapsible along said central fold lines of said opposing end walls.

6. A liner assembly in accordance with claim 1, wherein said liner assembly is configured to be positioned within a carton having opposing end walls and opposing side walls, and wherein said liner is configured to receive a product within said liner such that said liner body is positioned between the product and said inner surface of said frame.

7. A liner assembly in accordance with claim 6, wherein said frame and liner are moveable relative to the carton and product such that said frame and liner extend upwardly away from a top edge of the carton creating a volume above the product, wherein the volume is configured to receive a cooling medium within said liner and frame for cooling the product.

8. A liner assembly in accordance with claim 1, wherein a top edge of said liner is proximate the top edge of at least one of said walls.

9. A liquid impermeable carton system, said system comprising:
an outer carton comprising opposing end walls, opposing side walls, a bottom, and a cavity for housing a product, each of said outer carton walls having a top edge;
a frame comprising opposing end walls, and opposing side walls, said frame walls being connected together defining an open top portion and an open bottom portion, each of said frame walls further comprises a top edge, a bottom edge, an inner surface, and an outer surface; and
a liquid impermeable liner comprising a body and a bottom, said liner body coupled to at least one of said frame walls, said liner extendible below said bottom portion of said frame,
wherein said outer carton is configured to receive said frame and said liner within said cavity with the product positioned within said liner, said frame moveable relative to said outer carton from a first position wherein said frame is positioned within said cavity to a second position wherein at least a portion of said frame is positioned above the top edge of said outer carton.

10. A liquid impermeable carton system in accordance with claim 9, wherein, when said frame is in the first position, said liner bottom is adjacent said outer carton bottom, said frame side walls are adjacent said outer carton side walls, and said frame end walls are adjacent said outer carton end walls.

11. A liquid impermeable carton system in accordance with claim 9, wherein, when said frame is in the second position, said liner bottom is adjacent said outer carton bottom, at least a portion of said frame side walls are adjacent at least a portion of said outer carton side walls, and at least a portion of said frame end walls are adjacent at least a portion of said outer carton end walls.

12. A liquid impermeable carton system in accordance with claim 9, wherein said outer carton further comprises a top formed from a plurality of top flaps, the top flaps are closeable and provide access to the product included within the cavity.

13. A liquid impermeable carton system in accordance with claim 9, wherein said product comprises a plurality of beverage containers.

14. A liquid impermeable carton system in accordance with claim 13, wherein said liner and said frame are configured to receive a cooling medium for cooling the beverage containers when the frame is in the second position.

15. A liquid impermeable carton system in accordance with claim 9, wherein said outer carton further comprises a top formed from a plurality of top flaps, wherein, when the frame is in the first position, the top flaps are closeable such that the product can be shipped within the carton system, and wherein at a point-of-use the top flaps are openable to allow movement of the frame from the first position to the second position for creating a volume above the product for receiving a cooling medium for cooling the product.

16. A method for manufacturing a liquid impermeable carton system, said method comprising:
providing a frame including opposing end walls, and opposing side walls, the walls being connected together defining an open top portion and an open bottom portion, each wall further including a top edge, a bottom edge, an inner surface, and an outer surface;
attaching a liquid impermeable liner to at least one of the frame walls, the liquid impermeable liner including a body and a bottom, the liner extendible below the bottom portion of the frame; and
inserting the frame and the liner into an outer carton, the outer carton including opposing end walls, opposing side walls, a bottom, a closeable top, and a cavity for housing a product, each outer carton wall including a top edge, the liner configured to receive a product therein, the frame moveable relative to the outer carton from a first position wherein the frame is positioned within the cavity to a second position wherein at least a portion of the frame is positioned above the top edge of the outer carton.

17. A method for manufacturing a liquid impermeable carton system in accordance with claim 16, said method further comprising inserting the frame and the liner into the outer carton for receiving the product into the outer carton and within the liner, the liner body being positioned between the frame and the product and the liner bottom being positioned between the outer carton bottom and the product.

18. A method for manufacturing a liquid impermeable carton system in accordance with claim 16, wherein inserting the frame and the liner further comprises:
positioning the frame and the liner within the cavity in the first position;
inserting the product within the cavity and the liner; and
closing the outer carton top such that the product and the carton system are transportable.

19. A method for manufacturing a liquid impermeable carton system in accordance with claim 16, wherein inserting the frame and the liner further comprises:
opening the top of the outer carton;
moving the frame from the first position to the second position for creating a volume above the product; and
inserting a cooling medium within the volume for cooling the product included within the cavity.

20. A method for manufacturing a liquid impermeable carton system in accordance with claim 16, wherein providing a frame further comprises:
providing a frame wherein each of the opposing end walls includes two end panels connected together along a central fold line such that the frame is collapsible along the central fold lines of the opposing end walls.
